(19) United States
(12) Patent Application Publication
(10) Pub. No.: US 2026/0364974 A1
(43) Pub. Date: Nov. 19, 2026

(54) MODULAR AIRLESS TIRE

(71) Applicant: Tanapol Samrittivanicha, Los Angeles, CA (US)

(72) Inventor: Tanapol Samrittivanicha, Los Angeles, CA (US)

(21) Appl. No.: 19/207,231

(22) Filed: May 13, 2025

(51) Int. Cl. B60C 7/08

(52) U.S. Cl. CPC B60C 7/08

(57) ABSTRACT

The present disclosure provides an airless tire having a cylindrical tread ring, a plurality of modular tread mounting elements, each in a shape of a circular segment and each having a first connector at one circumferential end and a second connector at a second circumferential end, such that the modular tread mounting elements fit together at the first and second connectors to form a tread mounting ring, and each modular tread mounting element has at least one passage and at least one wire passing along the passage substantially around the tread mounting ring. The tread mounting ring has the tread ring mounted on it and also has an inner, annular surface shaped to engage a rim and barrel of a wheel. There is a mechanism for tightening the wires to hold the modular tread mounting elements together and with radially inward force.

### FIELD OF INVENTION

The present disclosure relates to airless or non-pneumatic tires (NPTs).

### BACKGROUND

Pneumatic tires, i.e., air-filled tires, have been used since at least as early as the 1800s. Pneumatic tires work well to reduce rolling resistance compared to typical solid tires and are relatively lightweight as well as resilient. For bicycles, automobiles, trucks and many other vehicles that use pneumatic tires, the tires are mounted on wheel rims. The radially inner edges of the tires have “beads” that fit into or otherwise mate with an inner part of a wheel rim structure, sometimes called a rim bead seat. Mounting a pneumatic tire on a wheel can be cumbersome and is often a challenge to do without equipment and substantial experience.

Moreover, pneumatic tires are vulnerable to flats. Flats can be difficult to fix as well as dangerous when one is trying to fix a flat or replace the flat with a spare while at the side of the road. Some flats, such as from a puncture in the sidewall of a tire, or a sizable puncture in the crown of a tire, cannot be fixed. In addition, when the tire's life is over due to tread wear or an unfixable flat, there is no reliable way to replace the tread. Generally, the entire tire must be replaced, wasting a lot of rubber.

NPTs have been developed in more recent years. NPTs are flat-resistant since there is no air in the tire. However, NPTs tend to be heavier, use more material and have more rolling resistance than pneumatic tires and therefore require increased energy (more user exertion for user-propelled vehicles and devices and more battery power consumption or greater gas consumption for motor or engine driven vehicles and devices).

In addition, past airless tire designs have often suffered from excessive rigidity resulting in a harsh ride and susceptibility to heat build-up due to poor heat dissipation, making NPTs vulnerable to damage, especially for higher speed applications such as for cars and motorcycles.

NPTs have also tended to have a high cost relative to pneumatic tires due to materials used and structural complexity and/or use of specialized and/or modified wheels. NPTs are not readily amenable to mounting on rims as they tend to be more rigid than pneumatic tires, especially compared to deflated pneumatic tires, and NPTs do not have air pressure to help hold the tires on the rims. Accordingly, NPTs are typically mounted on specialized or modified wheels, which increase the cost of NPTs substantially.

NPTs have also tended to suffer from reduced overall performance and durability in prior designs compared to pneumatic tires.

While modular NPTs have been proposed to try to simplify mounting the tire on a wheel, mounting the modular elements together and onto the wheel sufficient to withstand forces during use of the tire is not easy.

### SUMMARY

This summary is provided to introduce some concepts in a simplified form that are further described below in the detailed description. This summary is not intended to identify key features or essential features of the claimed subject matter, nor is it intended to be used as an aid in determining the scope of the claimed subject matter.

In one embodiment there is an airless tire having an annular or cylindrical tread ring, a plurality of modular tread mounting elements, each in a shape of a circular segment (arc) and each having a first connector at one circumferential end and a second connector at a second circumferential end, such that the modular tread mounting elements fit together at the first and second connectors to form a tread mounting ring, and each modular tread mounting element has at least one passage and at least one wire passing along the passage such that when assembled, the wire or wires extend around or substantially around the tread mounting ring. The tread mounting ring has the tread ring mounted on and around its outer annular surface, and also has an inner annular surface shaped to engage a rim and barrel of a wheel. There is a mechanism for tightening the wire or wires to hold the modular tread mounting members together and with radially inward force.

The foregoing general description of one or more illustrative embodiments and the following detailed description thereof are merely exemplary aspects of the teachings of this disclosure and are not restrictive. More details as well as other embodiments and variations are described in the detailed description and/or shown in the drawings.

BRIEF DESCRIPTION OF FIGURES Non-limiting and non-exhaustive examples are described with reference to the following figures.

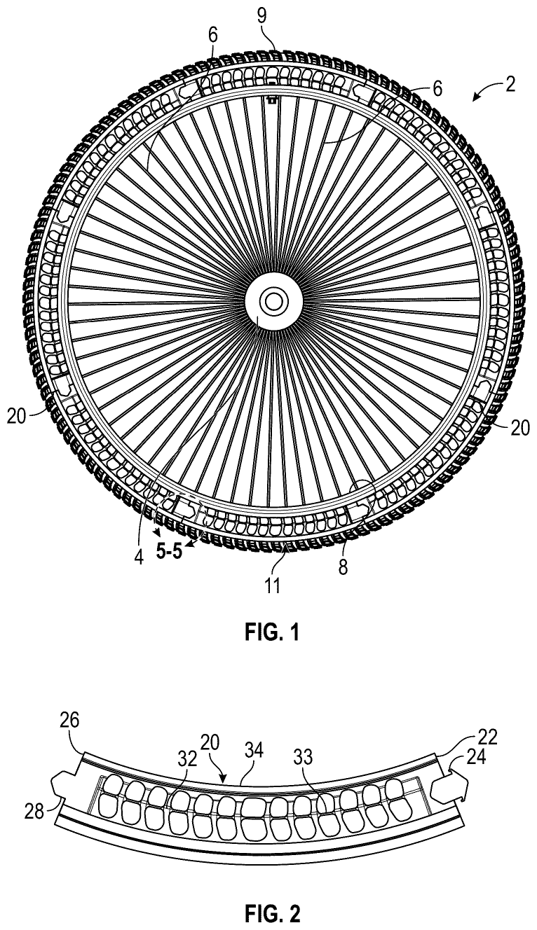

FIG. 1 illustrates a side view of an airless tire mounted on a wheel in an operational configuration, according to aspects of the present disclosure.

FIG. 2 illustrates an enlarged side view of a modular tread mounting element of the airless tire oriented with its outer, tread mounting surface facing downward, according to an embodiment.

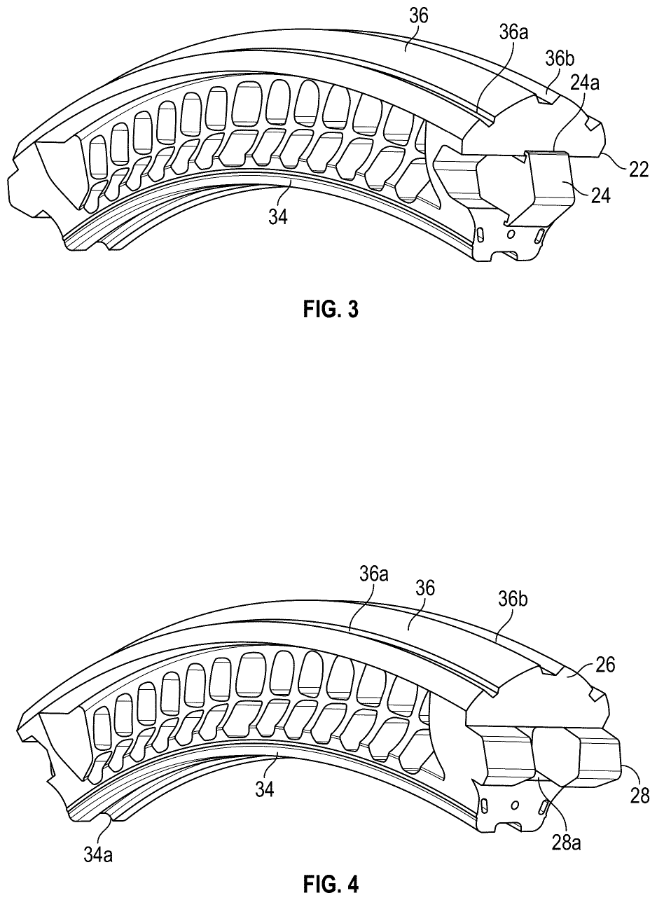

FIG. 3 illustrates an enlarged perspective view of a modular tread mounting element of the airless tire oriented with its outer, tread mounting surface facing upward showing a first circumferential end of the modular tread mounting element, according to aspects of the present disclosure.

FIG. 4 illustrates an enlarged perspective view similar to that of FIG. 3 showing a second circumferential end of the modular tread mounting element, according to an embodiment.

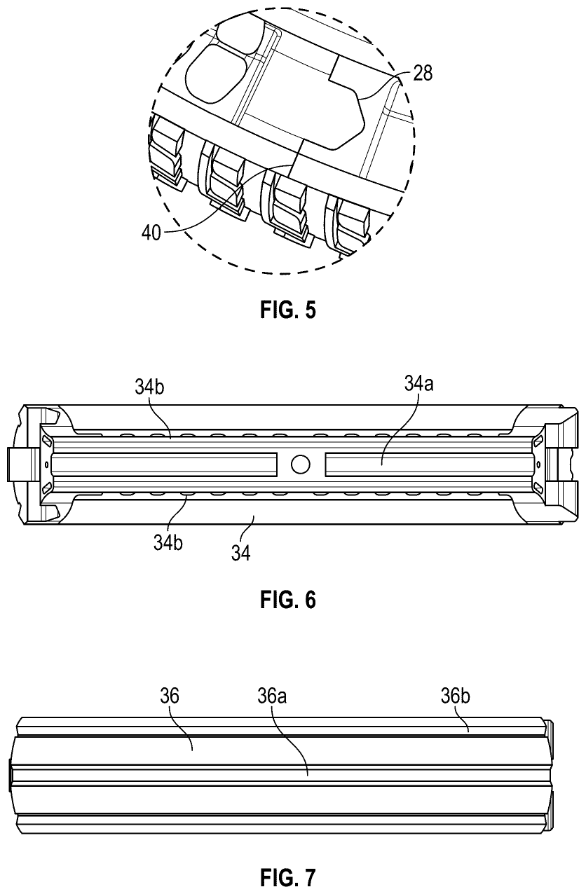

FIG. 5 illustrates an enlarged side view of a portion represented by the circle 5-5 of the airless tire of FIG. 1, showing where two modular tread mounting elements connect, according to aspects of the present disclosure.

FIG. 6 illustrates a bottom view of a modular tread mounting element, according to an embodiment.

FIG. 7 illustrates a top view of a modular tread mounting element, according to an embodiment.

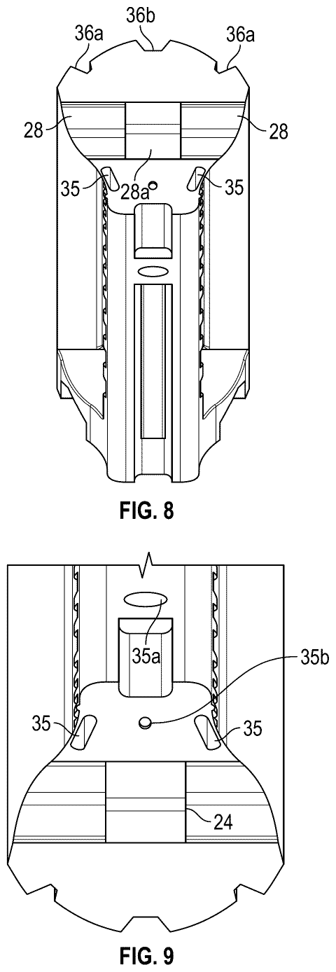

FIG. 8 illustrates a close-up view of the second circumferential end of a modular tread mounting element showing end openings of two passages formed in the second circumferential end of a modular tread mounting element, according to an embodiment.

FIG. 9 illustrates an enlarged view proximate the first circumferential end of a modular tread mounting element showing a bottom opening for the passages formed in the modular tread mounting element, according to an embodiment.

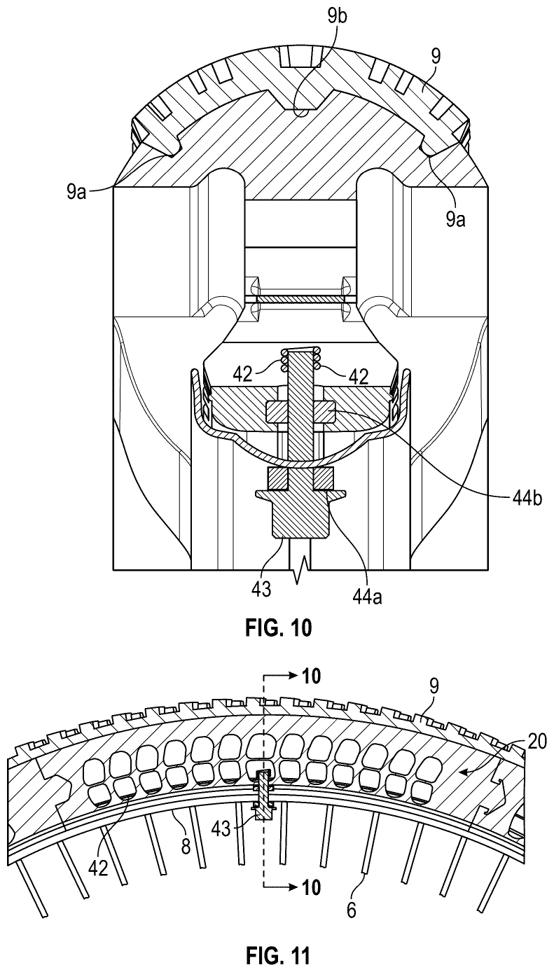

FIG. 10 illustrates an enlarged vertical sectional view of a modular tread mounting element and tread ring taken along line 10-10 of FIG. 11 showing wires that have passed through the bottom openings to the two passages in the modular tread mounting element along with a tread tightening mechanism, according to an embodiment.

FIG. 11 illustrates a side view of a portion of an airless tire and wheel showing part of the tread tightening mechanism connected through the wheel to the bottom of a modular tread mounting element, according to an embodiment.

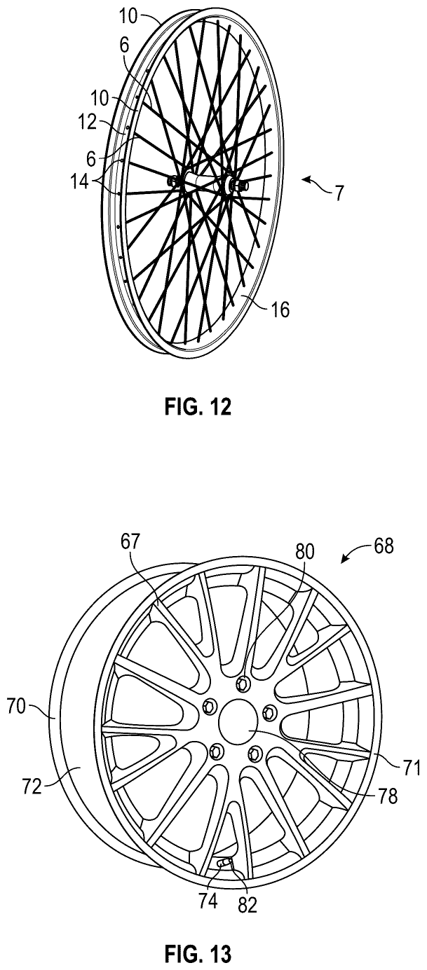

FIG. 12 illustrates a front perspective view of an exemplary wheel, such as for a bicycle on which the airless tire may be mounted, according to an embodiment.

FIG. 13 illustrates a front perspective view of an exemplary wheel, such as for an automobile on which the airless tire may be mounted, according to an embodiment.

### DETAILED DESCRIPTION

The invention now will be described more fully hereinafter with reference to the accompanying drawings, in which embodiments of the invention are shown. This invention may however be embodied in many different forms and should not be construed as limited to the embodiments set forth herein. Rather, these embodiments are provided so that this disclosure will be thorough and complete, and will fully convey the scope of the invention to those skilled in the art.

It will be understood that when an element is referred to as being “on” another element, it can be directly on the other element or intervening elements may be present therebetween. As used herein, the term “and/or” includes any and all combinations of one or more of the associated listed items.

It will be understood that, although the terms first, second, third etc. may be used herein to describe various elements, components, regions, layers, and/or sections, these elements, components, regions, layers, and/or sections should not be limited by these terms. These terms are only used to distinguish one element, component, region, layer, and/or section from another element, component, region, layer, and/or section.

It will be understood that the elements, components, regions, layers and sections depicted in the figures are not necessarily drawn to scale.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Furthermore, relative terms, such as “lower” or “bottom,” “upper” or “top,” “left” or “right,” “above” or “below,” “front” or “rear,” may be used herein to describe one element's relationship to another element as illustrated in the Figures. It will be understood that relative terms are intended to encompass different orientations of the device in addition to the orientation depicted in the Figures.

Unless otherwise defined, all terms used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Exemplary embodiments of the present invention are described herein with reference to idealized embodiments of the present invention. As such, variations from the shapes of the illustrations as a result, for example, of manufacturing techniques and/or tolerances, are to be expected. Any numbers, ratios, percentages, and other values do not preclude use of other values or other ranges in which the claimed and/or disclosed invention may operate. The terms about, approximately, or substantially may include values known to those having ordinary skill in the art. If not known in the art and/or otherwise specifically limited herein, these terms may be considered to be in the range of up to ±5%, ±10%, or other value higher than these ranges commonly accepted by those having ordinary skill in the art for the variable disclosed and/or in which the claimed and/or disclosed invention may operate. Thus, embodiments of the present invention should not be construed as limited to the particular shapes of regions illustrated herein but are to include deviations in shapes that result, for example, from manufacturing. The invention illustratively disclosed and/or claimed herein suitably may be practiced in the absence of any elements that are not specifically disclosed herein. Any and all patents, patent applications and non-patent literature cited through this Specification are hereby incorporated by reference in their entireties. References cited in an Information Disclosure Statement should not be construed as an admission that the cited reference comes from an area that is analogous or directly applicable to the invention, but rather that the reference is being cited out of an abundance of caution.

The airless tire described herein may be used on a wheel for any vehicle or other movable device. By way of nonlimiting examples, vehicles may include automobiles, trucks, tractors, bicycles, tricycles, unicycles, handcycles, aircraft, buses, golf carts, off road vehicles, fire trucks, and industrial vehicles. Also by way of nonlimiting examples, devices may include wheelchairs, wheel barrels, carts, trailers, forklifts, aerial lifts and industrial equipment.

In some preferred embodiments, the airless tire described herein is preferably for use on a standard wheel having a barrel and rims for mounting a pneumatic tire. In other embodiments, the airless tire described herein may be used on a wheel modified to fit with the airless tire.

In some cases, the airless tire may replace a pneumatic tire with an inner tube and/or a pneumatic tire without an inner tube.

FIG. 1 illustrates a side view of an airless tire mounted on a wheel in an operational configuration, according to various embodiments. The embodiment of FIG. 1 may be used, for example, on a bicycle wheel, among other types of wheels.

The airless tire of FIG. 1 is shown in combination with a wheel, i.e., a wheel and tire combination 2. The wheel has a hub 4, a plurality of spokes 6 and a rim region 8 sometimes referred to as a rim. With reference also to FIGS. 2 and 5, the airless tire has a tread ring 9, a web portion and multiple (at least two) modular tread mounting elements 20. FIG. 1 shows, by way of example, eight modular tread mounting elements 20 to make up tread mounting ring 11, located between the wheel's rim region 8 and the tread ring 9. There preferably should be at least three modular tread mounting elements 20 to make up the tread mounting ring 11.

Details of the rim region 8 (FIG. 1) for a typical bicycle wheel 7 and other vehicles and devices are shown in FIG. 12. The bicycle wheel's rim region has rim edges 10, a barrel 12 and nipples 14 that pass through the barrel and provide a threaded connection to spokes 6. A valve hole 16, typically for a Schrader valve to pass through, is also shown.

For a vehicle wheel 68 such as for an automobile, details are shown in FIG. 13. The wheel has spokes 67, a rim 70, an outer lip 71 a barrel 72, a valve hole 74 (or valve stem hole), a hub area having a center cap 78 and lug holes for lug nuts 80 (that connect the wheel to a wheel stud). There is also a valve stem 82 that passes through the valve hole 74 formed in the wheel.

As shown in FIG. 2, each modular tread mounting element 20 has a first circumferential end 22 with a male connector 24 and a second circumferential end 26 with a female connector 28. The modular tread mounting element 20 is preferably an arc, i.e., a segment of a circle. The segment size may be expressed as a portion of a circle. Where there are N segments that make up the tread mounting ring 11, the segment or arc of modular tread mounting element 20 extends is expressed by 360° divided by N. For example, if there are four modular tread mounting elements, N is four and so 360° divided by four is 90°. It should be noted that while it is preferred that each modular tread mounting element 20 is identical or substantially identical, it is possible to make some or all modular tread mounting elements 20 different segment lengths. In FIG. 1, N equals eight, therefore it is preferable that each modular tread mounting element 20 have an arc or segment length of 45°. When N equals three, the segments are 120°.

With continued reference to FIG. 2, each modular tread mounting element has the web portion disposed between the first and second circumferential ends 22, 26. The web portion has radial members 32 and a horizontal reinforcing member 33.

Tread ring 9 preferably is a separate element from tread mounting ring 11 to facilitate replacement of the tread ring 9 when it wears out or otherwise needs to be changed. In a lesser preferred variation, one could make tread ring 9 into segments of a size which is the same length as each modular tread mounting element, and could mold or otherwise affix each segment of tread ring 9 onto its corresponding modular tread mounting element 20

With reference to FIGS. 3-4 and 6-7, first circumferential end 22 has male connector 24 and second circumferential end 26 has a female connector 28 forming a space 28a. Modular tread mounting element 20 has an inner radial surface 34 and an outer radial surface 36. The inner radial surface 34 may have rim-receiving channels 34b that press fit, snap fit and/or friction fit onto the rim edges 10 of a wheel such as wheel 7 or wheel 68. Inner radial surface 34 also may have a U-shaped medial channel 34a.

Outer radial surface 36 may have outer bead-receiving channels 36a and a medial bead-receiving channel 36b which receive outer beads 9a and medial bead 9b, respectively, of tread ring 9, as shown, e.g., in FIG. 10. The fit may be by friction fit, press fit and/or snap fit.

In FIG. 5, which is an enlarged view of the portion of FIG. 1 denoted by circle 5-5, female connector 28 is shown. Male connector 24 is located in the space 28a formed by the female connector 28. See, e.g., FIGS. 3-4 and 8-9. The male connector 24 may have ridges or bulges 24a at upper and lower portions thereof in order to snap fit into corresponding complementary shaped portions of female connector 28 proximate a top and bottom of space 28a. In addition, it may be seen that adjacent modular tread mounting elements 20 abut or meet at a junction 40.

Further details may be seen in FIGS. 8-10. For example, as shown in FIG. 8, each modular tread mounting element 20 has one or more passages 35. FIGS. 8-9 show two passages 35. The passages 35 are located in each modular tread mounting element 20 and are open at the first circumferential end 22 and the second circumferential end 26 of each modular tread mounting element 20, forming entry/exit points. In other words the passages 35 have end openings where the passages of each modular tread mounting element communicate with each other (at the junction 40, where the male connector 24 of each modular tread mounting element mates with the female connector 28), such that when mounted on a wheel, the passages 35 in effect extend all or substantially all the way around the tread mounting ring 11.

FIG. 10 shows a fastening member or members such as a wire or wires 42 that pass through passages 35 and go all or substantially all of the way around the tread mounting ring 11. The passages 35, where there are two, may be located on either side of a medial plane extending in a radial direction of each modular tread mounting element 20 and preferably are, but not necessarily, symmetrically placed about the medial plane. Also shown in FIG. 9 is a central passage 35b that may be used with a single wire embodiment, i.e., where one wire is used.

With reference to FIGS. 10 and 11, tread ring 9, one or two wires 42 and a tightening mechanism including a tightening member 43 such as a bolt may be seen. In the case of one wire 42 it should pass through passage 35b (FIG. 9), preferably centrally located between sides of the modular tread mounting elements. In the case of two wires 42, preferably they should pass through passages 35, each preferably proximate opposite sides of the modular tread mounting elements. The tightening member or bolt 43 is preferably disposed in the air valve hole in the wheel. The tightening mechanism also includes nuts 44a and 44b secure the tread ring 9 to the rim region 8 of the wheel at the rim edges and barrel. The inner radial surface of each of the modular tread mounting elements (and thus the tread ring) preferably has a substantially complementary shape to that of the wheel on which it is to be mounted or is mounted on. Also preferably the wheel is a standard wheel for the type of vehicle or device that the airless tire is to be mounted on or is mounted on.

More specifically, the ends of the wire or two wires 42 preferably connect through a hole or holes in tightening member 43, where FIG. 10 shows the wires passing through the tightening member. There may be other ways of connecting the wires to the tightening member or bolt such as by solder or tying or otherwise fixing or connecting. Alternatively or additionally, in a lesser preferred embodiment, one end of the wire or wires may be soldered or tied or otherwise fixed or connected to the wheel or one of the modular tread mounting elements.

To put the airless tire together, one threads the wire or wires 42 through the passages 35 in the modular tread mounting elements 20 stringing the elements together with the first and second circumferential ends 22, 26, respectively, of each adjacent modular tread mounting element 20 facing each other, such that the male and female connectors 24, 28, respectively, face each other. This threading and/or fixing of the wire or wires 42 can be done at the time of manufacturing or later.

Then one places the modular tread mounting elements 20 on a wheel so that the rim channels 34b on the lower tread mounting surface 34 fit over, e.g., rim edges 10 of wheel 7 (FIG. 12) or the rim 70 and outer lip 71 of wheel 68 (FIG. 13). In addition, for a wheel such as wheel 7, U-shaped medial channel 34a is positioned with nipples 12 located in it. Ideally, the modular tread mounting elements 20 snap fit, press fit and/or friction fit (or otherwise fit) into place on rim edges of the wheel (or rim and outer lip).

One also presses the male connectors 24 into the female connectors 28, which also preferably snap fit, press fit and/or friction fit or otherwise fit together. Then preferably one makes sure, as shown in FIGS. 9-10, to position the modular tread mounting elements 20 such that an opening 35a in or near the bottom of one of the modular tread mounting elements 20 is proximate and may also align with the valve hole 16 (FIG. 12) where tightening member 43 is or will be located (FIGS. 10-11). One threads the wire or wires 42 at its end or their ends through the tightening member 43 which may be threaded, e.g., a bolt. Alternatively, one may tie and/or solder or otherwise affix the wire or wires to the tightening member 43. One also makes sure that all of the modular tread mounting elements are properly seated in place on the rim edges and barrel. The last two tread mounting elements 20 may need to be pressed down onto the rims and barrel of the wheel harder than the other modular tread mounting elements in order to get the male and female ends to fully mate. There is preferably a cam surface at the ends of the male and female members to facilitate proper mating.

Then one tightens the wire or wires using the tightening member 43 (e.g., by turning it). Where the tightening member is a bolt, one may tighten the bolt to wind or further wind the wire or wires around the bolt and thereby tighten the wire or wires. This in turn tightens the attachment or fit of the modular tread mounting elements to the wheel. The tightening member could instead be formed by tying the wire or wires to themselves or otherwise turning or wrapping the wire(s) to themselves, and twisting like a twist tie or otherwise tightening to itself or themselves. Another tightening member could be a band with a screw or bolt or the like that of a worm gear clamp, screw band clamp or screw-type hose clamp.

Tightening member 43 acts as a wire tightening or loosening mechanism, which tightens or loosens the fit of and holding force acting on the inner radial surface of each of the modular tread mounting elements to the wheel and each other. Part of tightening member 43 may be located at an inner side (with respect to a radius) of the barrel of the wheel and the other part may be located on the outer side (with respect to the radius) of the barrel of the wheel. The wire's ends or wires' ends may be fitted through a hole or holes in the bolt or maybe tied or otherwise fixed to the bolt. Alternatively, one could fix one end of the wire or wires to a modular tread mounting element and the other end of the wire or wires to the tightening member. Instead of two wires, one could also use one wire to extend through both passages 35 if there are two passages, or only one passage and one wire could be provided.

Once all of the modular tread mounting elements 20 are fixed on the wheel forming the tread mounting ring 11, the tread ring 9 may be put on the tread mounting ring. The tread ring 9 is ideally biased inward when mounted on the tread mounting ring 11. Therefore, one must stretch out the tread ring 9 a little when putting it on the tread mounting ring 11. One way to do that is to pull or place part of the tread ring 9 on a corresponding part of the tread mounting ring. Then one can pull another part of the tread ring 9 onto its corresponding part of the tread mounting ring 11 and so on until one has all of the tread ring 9 over the outer radial surface 36 of the modular tread mounting elements forming the tread mounting ring. One then keeps pulling the tread ring 9 over the outer radial surface to get the outer bead-receiving channels 36a and a medial bead-receiving channel 36b to receive outer beads 9a and medial bead 9b, respectively, of tread ring 9, as shown, e.g., in FIG. 10. The tire is then mounted for operation.

To change out the tread ring 9, one removes the old tread ring by reversing the above process and then repeats the above process with the new tread ring.

Embodiments may be implemented with various alternative structures to enhance functionality and adaptability and/or reduce the cost of manufacture and/or for other effects.

In some embodiments the airless tires described and/or claimed herein may be used for vehicles and wheeled devices of all types. In some embodiments the airless tires described and/or claimed herein perform without the need for inflation, thereby reducing the risk of accidents caused by punctures or leaks. In addition, the need to change a tire by the roadside due to punctures or leaks is eliminated since the tires are not inflated.

In some embodiments the airless tires described and/or claimed herein may have a replaceable tread. This enables the user to switch out the tread when worn out or changed to a different pattern to better suit the conditions during use as needed.

In some embodiments the overall feel to the user (due to resiliency) of the tire is evaluated under real-world driving and/or use conditions. In practice, a tire's performance is often determined by two main factors: the rubber compound formulation (i.e., the blend of natural rubber, synthetic rubber, and elastomers) and the tire's structural design. The materials can be selected as known to one of ordinary skill in the art.

In some embodiments, the specific rubber compound for the tread and/or the modular tread mounting elements may be achieved at least in part by varying the ratio and type of elastomers being used to pursue a desired balance of flexibility, recovery, and durability depending on taste and/or on the type of vehicle or device for which the airless tire is being adapted.

In some embodiments one may use standard components for the rubber compound formulation including components known to one of ordinary skill in the industry. For example, carbon black is a known reinforcing filler and standard chemical additives used in rubber compounding may also be known in the art. In some embodiments polymers or other compounds may be added to rubber to strengthen and/or increase rigidity of the rubber.

In some embodiments, goals of high resilience for good recovery after tread and/or modular tread ring elements deform is desirable. In addition, durability due to high strength and tear resistance is also desirable in some embodiments, as is road grip while achieving limited wear.

In some embodiments an airless tire as disclosed and/or claimed herein may be designed by performing an initial CAD design, modeling modular tread ring elements and tread rings using an application such as SolidWorks or similar CAD software to create a detailed 3D design, and then performing simulation testing using well-known simulation software to identify stress points and potential failure areas under expected real-world conditions.

In some embodiments, depending on the results of simulations, e.g., if any weak points or issues are detected, the design may be modified to address those and then simulations may be performed again until a desired tire design is achieved. That is, the design and simulation cycle continues until the simulation results indicate that the tire structure meets all desired strength, weight, and performance requirements with no observed problems or only insignificant problems.

In some embodiments an airless tire as disclosed and/or claimed herein may be designed with goal of making the weight as light as possible yet achieving strength and durability and supporting operational loads without failure.

In some embodiments an airless tire as disclosed and/or claimed herein may be designed with goal of making the tire simple to assemble and mount on or remove from and replace on a wheel.

In some embodiments the tread may be self-healing.

In some embodiments the tread portion of the tread ring may have a typical thickness for a comparable pneumatic tire and/or the modular tread mounting elements together with the tread ring may have a comparable thickness or height to that of a comparable pneumatic tire or at least not significantly different.

More specifically, in some embodiments an airless tire as disclosed and/or claimed herein may be designed generally with a base thickness (groove depth) of the tread to be comparable to conventional tires. Typically, this thickness ranges from about 3 to 6millimeters—depending on the tire's intended use but more rugged designs may reach as high as 12 millimeters or more. For a bicycle design such as for a “beach cruiser,” the base thickness may be, in some embodiments, approximately 3.5 millimeters thick.

In some embodiments an airless tire as disclosed and/or claimed herein may be designed with a tread pattern similar to that of conventional tires for the vehicle and/or device for which the airless tire is being designed.

In some embodiments an airless tire as disclosed and/or claimed herein may be designed with goal of achieving simple, easy installation and secure attachment to a wheel to minimize the risk of the tire coming off during operation.

In many embodiments, the airless tire described and/or claimed herein may be mounted by a typical user, even without tools.

The tread ring is preferably stretchable, by about ten to twenty percent, to help facilitate mounting it on and removing it from the tread mounting ring 11. The tread ring has a three bead design in a most preferred embodiment to facilitate a secure attachment to the tread mounting ring 11. However, the number of beads may vary from one to multiple.

The modular tread mounting elements, the wire or wires and the tread ring may be made of various different materials. For example, in some embodiments, natural rubber, synthetic rubber, and an elastomer or of elastomers may be used. In some embodiments for the tire structure, namely, the modular tread mounting elements may use a compound that is stiff enough to support the load yet light in weight. For the tread ring, in some embodiments it is desirable to achieve excellent grip, flexibility, and resistance to wear.

Achieving a lightweight yet durable structure required balancing material properties and geometry to withstand real-world stresses.

In some embodiments a method of manufacturing a tread ring and/or modular tread mounting elements may be injection molding or other forming or molding methods. In some embodiments one of the nuts, i.e., the nut disposed in the modular tread mounting element, may be molded with the modular tread mounting element.

In some embodiments the wire or wires are preferably steel for strength, although other materials, e.g., nylon, copper, aluminum, and brass. For example, nylon may be suitable particularly for airless tires adapted for lower speed and relatively gentle use. In some embodiments, as disclosed herein, at least one fastening member may be used, e.g., one wire may be used, in other embodiments two wires may be used, and further it is possible to use three or more wires.

A number of implementations have been described. Nevertheless, it will be understood that various modifications may be made without departing from the spirit and scope of the disclosure. Accordingly, other implementations are within the scope of the following claims.

1. An airless tire comprising:
an annular tread ring having a radially outer surface with a tread thereon and a radially inner surface;
a plurality of modular tread mounting elements, each in a shape of a segment of a circle and each having a first connector proximate one end in the circumferential direction and a second connector proximate another the other end in the circumferential direction;
wherein the modular tread mounting elements fit together at their respective first and second connectors to form an annular tread mounting ring;
wherein each of the modular tread mounting elements has at least one passage to form at least one annular passage in the tread mounting ring;
at least one fastening member passing through the at least one passage so as to extend substantially around the tread mounting ring;
wherein the tread mounting ring has an outer annular surface on which the tread ring is mounted and an annular inner surface; and
a mechanism for tightening the at least one fastening member to hold the tread mounting ring radially inward.
wherein the mechanism for tightening comprises a threaded member that is adapted for passing through a valve stem opening in a standard wheel.

2. The airless tire of claim 1, wherein the radially inner surface of the tread ring has three beads that extend radially downward and the outer annular surface of the tread mounting ring has three channels into which the three beads, respectively, are at least one of friction fit, press fit and snap fit therein.

3. The airless tire of claim 1, wherein the annular inner surface of each of the modular tread mounting elements has a substantially complementary shape to a rim and barrel of the wheel.

4. The airless tire of claim 1, wherein the plurality of modular tread mounting elements forming the tread mounting ring is at least three of the modular tread mounting elements.

5. The airless tire of claim 1, wherein the modular tread mounting elements each have an outer radial portion, and an inner radial portion, and a web of resilient members including radial members and a reinforcing member extending in the circumferential direction, and the web has a first radial position when the tire is not subject to inward radial force and a second radial position where the resilient members will deflect radially inward in response to pressure on the tread ring when the tire is in use, wherein the resilient members will return to the first annular position in response to the absence of pressure on the tread ring.

6. The airless tire of claim 1, wherein the at least one annular passage is formed by two annular passages, and the at least one fastening member is formed by two wires, the tire has a medial plane perpendicular to an axis of the airless tire, the medial plane bisecting the tire, wherein the two annular passages are disposed on opposite sides of the medial plane, and the two wires are disposed in one of each of the two annular passages.

7. (canceled)

8. The airless tire of claim 1, wherein the threaded member comprises a bolt.

9. The airless tire of claim 7, wherein the threaded member has at least one aperture therethrough for receiving the at least one fastening member.

10. A combination of an airless tire and a wheel, comprising:
a wheel;
an airless tire comprising:
an annular tread ring;
a plurality of modular tread mounting elements, each in a shape of a segment of a circle and each having a first connector proximate one end in the circumferential direction and a second connector proximate another the other end in the circumferential direction;
wherein the modular tread mounting elements fit together at their respective first and second connectors to form an annular tread mounting ring;
wherein each of the modular tread mounting elements has at least one passage to form at least one annular passage in the tread mounting ring;
at least one fastening member passing through the at least one passage so as to extend substantially around the tread mounting ring;
wherein the tread mounting ring has an outer annular surface on which the tread ring is mounted and an annular inner surface having a complementary shape to an outer radial surface of the wheel;
a mechanism for tightening the at least one fastening member to hold the tread mounting ring radially inward onto the outer radial surface of the wheel, wherein the wheel has a valve stem opening and wherein the mechanism for tightening comprises a threaded member that passes through the valve stem opening and connects to the at least one fastening member proximate the valve stem opening.

11. The combination of an airless tire and wheel of claim 10, wherein the radially inner surface of the tread ring has three beads that extend radially downward and the outer annular surface of the tread mounting ring has three channels into which the three beads, respectively, are at least one of friction fit, press fit and snap fit therein.

12. (canceled)

13. (canceled)

14. The combination of an airless tire and wheel of claim 10, wherein the modular tread mounting elements each have an outer radial portion, and an inner radial portion, and a web of resilient members including radial members and a reinforcing member extending in the circumferential direction, and the web has a first radial position when the tire is not subject to inward radial force and a second radial position where the resilient members will deflect radially inward in response to pressure on the tread ring when the tire is in use, wherein the resilient members will return to the first annular position in response to the absence of pressure on the tread ring.

15. The combination of an airless tire and wheel of claim 12, wherein the mechanism for tightening comprises a tightening member with threads and two nuts disposed on opposite sides of the valve stem opening with the tightening member threaded therethrough.

16. The combination of an airless tire and wheel of claim 15, wherein the tightening member comprises a bolt.

17. The combination of an airless tire and wheel of claim 10, wherein the wheel is one of a standard bicycle wheel and a standard automotive wheel.

18. The combination of an airless tire and wheel of claim 10, wherein the mechanism for tightening member comprises a threaded member that has at least one aperture therethrough for receiving the at least one fastening member.

19. The combination of an airless tire and wheel of claim 10, wherein the at least one annular passage is formed by two annular passages, and the at least one fastening member is formed by two wires, the tire has a medial plane perpendicular to an axis of the airless tire, the medial plane bisecting the tire, wherein the two annular passages are disposed on opposite sides of the medial plane, and the two wires are disposed in one of each of the two annular passages.

20. The combination of an airless tire and wheel of claim 10, wherein the plurality of modular tread mounting elements forming the tread mounting ring is at least three modular tread mounting elements.

21. A combination of an airless tire and a wheel, comprising:
a standard wheel for a bicycle or motor vehicle; and
an airless tire comprising:
an annular tread ring;
a plurality of modular tread mounting elements, each in a shape of a segment of a circle and each having a first connector proximate one end in the circumferential direction and a second connector proximate another the other end in the circumferential direction;
wherein the modular tread mounting elements fit together at their respective first and second connectors to form an annular tread mounting ring;
wherein each of the modular tread mounting elements has at least one passage to form at least one annular passage in the tread mounting ring;
at least one fastening member passing through the at least one passage so as to extend substantially around the tread mounting ring;
wherein the tread mounting ring has an outer annular surface on which the tread ring is mounted and an annular inner surface having a complementary shape to an outer radial surface of the wheel;
a mechanism for tightening the at least one fastening member to hold the tread mounting ring radially inward onto the outer radial surface of the wheel, wherein the wheel has a valve stem opening and wherein the mechanism for tightening comprises a threaded member that passes through the valve stem opening and connects to the at least one fastening member proximate the valve stem opening.
